(19) United States
(12) Patent Application Publication
(10) Pub. No.: US 2024/0270320 A1
(43) Pub. Date: Aug. 15, 2024

(54) Connecting Arrangement for Connecting a First Component to a Second Component for a Vehicle, and Method for Producing Such a Connecting Arrangement

(71) Applicant: Bayerische Motoren Werke Aktiengesellschaft, Muenchen (DE)

(72) Inventor: Gerhard BUTZ, Pfeffenhausen (DE)

(21) Appl. No.: 18/564,789

(22) PCT Filed: May 11, 2022
(86) PCT No.: PCT/EP2022/062783

§ 371 Date: Nov. 28, 2023

(30) Foreign Application Priority Data
Jun. 2, 2021 (DE) 10 2021 114 263.6

(51) Int. Cl. B62D 25/12

(52) U.S. Cl. CPC B62D 25/12

(57) ABSTRACT

A connecting arrangement for connecting a first component to a second component for a vehicle includes a peripheral region of the first component that is disposed in a folded pocket of the second component that is delimited by a crimped flange of the second component, where the crimped flange is crimped around the peripheral region such that the first component is connected to the second component. The first component has an outflow opening which adjoins the crimped flange and a liquid is dischargeable via the outflow opening from an interspace delimited by the first component and the second component. The outflow opening is closed by a sealing compound which covers a first subregion of the crimped flange and a second subregion, which adjoins the first subregion of the crimped flange and is disposed next to the outflow opening, of the first component.

### BACKGROUND AND SUMMARY

The invention relates to a connecting arrangement for connecting a first component to a second component for a vehicle. The invention also relates to a method for connecting a first component to a second component for a vehicle.

DE 42 24 423 A1 discloses a vehicle sheet-metal part comprising a crimped flange, which engages around an edge of a structural element that is spaced apart from a fold. EP 2 307 167 B1 furthermore discloses a method for integrally bonding folded flanges of exterior components of vehicle bodies. DE 10 2013 203 302 B4 discloses a method for producing a seal. EP 1 041 130 A2 moreover discloses a method for sealing a body portion by applying a sealing compound to the body portion.

An object of the present invention is to provide a connecting arrangement for connecting a first component to a second component for a vehicle and a method for connecting a first component to a second component for a vehicle, such that the components are connected to one another in particularly advantageous fashion and can be provided with a coating in particularly advantageous fashion.

A first aspect of the invention relates to a connecting arrangement for connecting a first component to a second component for a vehicle, which is preferably in the form of a motor vehicle. As explained in more detail below, in the case of the connecting arrangement the components are connected to one another, as a result of which the components form a structural unit, also referred to as structural element or structural part. In the completely produced state of the vehicle, the vehicle, which is in the form for example of an automobile, in particular a passenger car, comprises the structural part and therefore the components. Expressed differently again, the structural part and therefore the components are constituent parts of the vehicle in the completely produced state of the vehicle. Consequently, the components and therefore the structural part are used, for example, to produce the vehicle. Consequently, the connecting arrangement is produced, for example, in the course of production of the vehicle.

In the case of the connecting arrangement, a peripheral region of the first component is arranged in a folded pocket of the second component that is delimited by a crimped flange of the second component, which is crimped around the peripheral region of the first component, as a result of which the components are connected to one another, in particular in a form fit. In other words, the second component is folded around the peripheral region or over the peripheral region of the first component, in particular with formation of a fold.

In order now to connect the components to one another in particularly advantageous fashion and to be able to provide them with a coating, such as a layer of paint or coat of paint also referred to as paint finish, in particularly advantageous fashion, it is provided according to the invention that the first component has at least one outflow opening, which adjoins the crimped flange, is in the form of a through-opening, and via which a liquid can be discharged from an interspace between the components that is delimited by the components, in particular in each case directly, in particular when the components and thus the structural part are being provided with the coating. This means that the outflow opening per se, that is to say considered on its own, by way of one end leads into the interspace arranged between the components and delimited by the components, in particular directly in each case, and by way of the other end leads into a surroundings of the components and thus of the structural part. If, for example, the components connected to one another are provided with the aforementioned coating, in particular in a liquid state of the coating, in particular in such a way that the coating is applied to the components in a liquid state of the coating, wherein the outflow opening is open while the components are being provided with the coating, then excess liquid coating can flow through the open outflow opening and thus, via the open outflow opening, flow out of the interspace, with the result that the excess coating can flow out or drip off of the components or the structural part in particularly advantageous fashion. The excess coating should be understood in particular to mean that the rest of the coating remains on the components, in particular stays adhered there, wherein the excess does not remain on the components but instead can flow away or drip off of the components, in particular via the outflow opening.

In the case of the connecting arrangement, the outflow opening is closed by means of a sealing compound, which covers at least a first subregion of the crimped flange and at least a second subregion, which adjoins the first subregion of the crimped flange and is arranged next to the outflow opening, of the first component and thus seals off the crimped flange with respect to the second subregion, and therefore seals the crimped flange. The sealing compound thus performs a dual function. Firstly, the sealing compound is used to seal the crimped flange, and therefore to seal off the crimped flange with respect to the second subregion, with the result that, for example in the completely produced state of the structural part, no dirt and no moisture can pass through between the crimped flange and the second component and enter the folded pocket. Secondly, the sealing compound is used to close and thus seal off the outflow opening, in particular after the components have been provided with the coating and after the excess coating has flowed out of the interspace. Therefore, in the completely produced state of the structural part, no dirt and no moisture can pass through the outflow opening and therefore enter the interspace, which, for example in the completely produced state of the structural part, is what is referred to as a dry space of the structural part, it being desirable to protect the dry space from dirt or moisture entering the dry space. It is evident that the invention makes it possible for the one part to connect the components to one another in particularly advantageous fashion by folding, or crimping, and by sealing the crimped flange, wherein, in particular by sealing the crimped flange, a fixed connection can be ensured between the components, in particular over a lengthy service life. The invention also makes it possible to provide the components with the coating in particularly advantageous fashion, since excess coating, that is to say the excess portion of the coating, can advantageously flow out of the interspace via the outflow opening, as a result of which undesired defects of the coating or lack of coating can be avoided. Moreover, the invention makes it possible to close the outflow opening in particularly favorable fashion in terms of time and costs and thus avoid undesired entry of dirt and moisture into the interspace. To that end, the outflow opening is closed by means of the sealing compound, which is also used to seal the crimped flange.

This makes it possible to avoid the use of an additional, separate plug for closing the outflow opening, for which it is also possible to avoid work steps for placing the plug. Placing the plug is to be understood as meaning that the plug is arranged at least partially in the outflow opening and is fastened to at least one of the components. The invention thus also makes it possible to produce the connecting arrangement in particularly favorable fashion in terms of time and costs.

The invention is based in particular on the following considerations: In order that outflow openings, also referred to as holes, can be closed by means of respective plugs, for example in an assembly unit for producing vehicles, a sufficient distance or installation space must usually be provided on the inside and outside to be able to realize a latching means and thus retaining means of the respective plug. This conventionally required distance can adversely affect ventilation of a structural part or the outflow or drainage of liquid from an interspace of the structural part, this possibly leading to errors in a coating, which is in the form for example of a CDC coating (CDC—cathodic dip coating). The invention makes it possible to avoid the aforementioned problem. Since the aforementioned structural part comprises the crimped-around and thus crimped second component, the structural part is a crimped structural part. The outflow opening makes it possible in this respect for the crimped structural part to be completely drained and ventilated, for example in a painting run-through, by means of which the structural part is provided with the coating, and/or in a CDC coating unit, which is in the form for example of a dipping bath and which provides the structural part with the coating. This is to be understood in particular as meaning that, when the structural part and thus the components are being provided with the coating, a liquid in the form of an excess portion can in particular completely flow out of the interspace via the outflow opening in advantageous fashion, and also air can in particular completely flow out of the interspace via the outflow opening in particularly advantageous fashion, and therefore the structural part can be in particular completely ventilated in particularly advantageous fashion.

Thereupon, the crimped flange can be sealed off with respect to the second subregion, and therefore the crimped flange can be sealed by means of the sealing compound, which is also referred to as crimped-flange seal or crimped-fold seal, reliably in terms of the process. It has been found that the sealing compound for the one part ensures advantageous closing and thus sealing off of the outflow opening. For the other part, the sealing compound makes it possible to ensure an advantageous visual appearance of the structural part.

In order to discharge the excess coating from the interspace in particularly advantageous fashion and thus be able to provide the components with the coating in particularly advantageous fashion, in one embodiment of the invention it is provided that the outflow opening is elongate, thus an elongate through-opening.

In this respect, it has been shown to be particularly advantageous if the elongate outflow opening has a direction of longitudinal extent, which is also referred to as first direction of longitudinal extent. For example, the outflow opening is arranged in a plane that extends perpendicularly to a direction of passage through the outflow opening, through which the liquid from the interspace can flow along the direction of passage and which thus, along the direction of passage, by way of one end leads into the interspace and by way of the other end leads into the surroundings. Here, the direction of longitudinal extent of the outflow opening extends in the plane and perpendicularly to the direction of passage. For example, the outflow opening has a width, which is substantially smaller than a length of the outflow opening that comprises the length along the direction of longitudinal extent, along a direction of extent of the outflow opening that extends in the plane and perpendicularly to the direction of longitudinal extent of the outflow opening. In particular, the length is at least three times, in particular at least four times and very particularly at least five times the width of the outflow opening.

In this respect, it has been shown to be particularly advantageous if the direction of longitudinal extent of the outflow opening extends obliquely or parallel to a direction of longitudinal extent of the crimped flange, the direction of longitudinal extent of which is also referred to as second direction of longitudinal extent. This allows the excess coating to flow out of the interspace via the outflow opening in particularly advantageous fashion, with the result that the components can be provided with the coating in particularly advantageous fashion. The second direction of longitudinal extent of the crimped flange can also be understood as meaning that the crimped flange extends along the second direction of longitudinal extent in elongate and in particular linear fashion.

In a particularly advantageous embodiment of the invention, the outflow opening is in the form of an slot. In this respect, the outflow opening is formed by cutting a region of material out of the first component. In particular, the outflow opening may have a stadium-shaped form. This is to be understood as meaning that the outflow opening for example has a contour, in particular an inner contour, which is formed by two parallel, mutually opposite straight lines in particular of the same length and by semicircular arcs adjoining the straight lines at either end. In particular, it can be provided here that the direction of passage points away from the crimped flange.

In a further, particularly advantageous embodiment of the invention, the outflow opening may be in the form of a gill, that is to say formed in the manner of a gill, and therefore the outflow opening is also referred to as crimped-fold gill. In this respect, the outflow opening is formed by cutting and then shaping the first component. It is in particular conceivable that the direction of passage points toward the crimped flange.

In order to be able to seal the crimped flange in particularly advantageous fashion and to close and therefore seal off the outflow opening in particularly advantageous fashion, it is provided in a further configuration of the invention that the sealing compound is made from a plastic.

It has been shown to be particularly advantageous here if the plastic is polyvinyl chloride (PVC), which makes it possible to realize particularly advantageous sealing and sealing off.

A further embodiment is distinguished in that a distance, which extends for example along the above-described direction of extent, between an intrinsically free end of the crimped flange and the outflow opening is at most 3 mm, in particular at most 2.5 mm. This makes it possible to ensure that the sealing compound for the one part seals the crimped flange in particularly advantageous fashion and for the other part closes and thus seals off the outflow opening in advantageous fashion.

Lastly, it has been shown to be particularly advantageous if the first component and/or the second component is made from a metal material, such as steel or a light metal, in particular aluminum. This makes it possible to connect the components to one another in particularly advantageous fashion by crimping or folding.

A second aspect of the invention relates to a method for connecting a first component to a second component for a vehicle. Consequently, the method according to the second aspect of the invention makes it possible for example to produce a connecting arrangement according to the first aspect of the invention. In the course of the method, the second component is crimped around a peripheral region of the first component, as a result of which a folded pocket delimited by a crimped flange of the second component is formed and the peripheral region of the component is arranged in the folded pocket. Moreover, this connects the components to one another. The feature that the folded pocket is delimited by the crimped flange is to be understood in particular to mean that the folded pocket is partially delimited or formed by the crimped flange. For example, the folded pocket is delimited on one side by the crimped flange and on the other side by a wall region of the second component, wherein the wall region of the second component is situated opposite the crimped flange and in particular is spaced apart from the crimped flange. It is conceivable here that the peripheral region of the first component is arranged between the crimped flange and the wall region. In particular, the crimped flange is formed in one piece with the wall region and connected to the wall region via a fold of the second component that is formed by the crimping. The fold is a second wall region of the second component, wherein the fold extends at least in arcuate fashion therein, since the second component is crimped around the peripheral region, as a result of which the fold is formed. In the process, the fold, or second wall region, is formed in one piece with the crimped flange and in one piece with the first wall region of the second component.

In order now to be able to connect the components to one another in particularly advantageous fashion and to provide them with a coating, in particular to paint them, in particularly advantageous fashion, in the case of the second aspect of the invention it is provided that the first component is provided with at least one outflow opening adjoining the crimped flange. In principle, it is conceivable for the outflow opening to be produced in the first component after the second component has been crimped. It has been shown to be particularly advantageous, however, if first of all the first component is provided with the outflow opening, for example by punching, and then the second component is crimped around the peripheral region, in such a way that the outflow opening adjoins the crimped flange after the crimping operation.

In particular after the crimping and in particular after the production of the outflow opening, the components are each provided at least partially with a coating, in particular in a liquid state of the coating. This is to be understood in particular to mean that for example the coating is applied to the components in a liquid state of the coating. For example, the coating, in particular in a liquid state of the coating, is sprayed onto the components or sprayed against the components, or the components, which are in particular connected to one another, are for example introduced, in particular dipped, into a bath which is formed by the coating in a liquid state of the coating and is also referred to as dipping bath, and thus provided with the coating.

Excess liquid coating is drained from an interspace, which is delimited by the components in particular in each case directly, via the outflow opening. This is to be understood in particular as meaning that the method is carried out in such a way that the excess liquid coating is allowed to flow out of the interspace via the still-open and thus opened-up outflow opening and therefore flow through the outflow opening.

In particular after the excess liquid coating has been drained from the interspace via the outflow opening, a sealing compound, in particular in a liquid state of the sealing compound, is applied at least to a first subregion of the crimped flange and to a second subregion, which adjoins the first part of the crimped flange and is arranged next to the outflow opening, of the first component. The liquid state of the sealing compound is to be understood as meaning in particular a viscous or pasty state of the sealing compound, which thereupon for example can harden or hardens and in particular in the completely produced state of the connecting arrangement or of the aforementioned structural part can be resin. The sealing compound is applied to the subregions in such a way that the sealing compound covers the subregions and thus seals off the crimped flange with respect to the second subregion, and therefore seals the crimped flange.

Moreover, it is provided that the outflow opening is closed and thus sealed off by means of the sealing compound. It has been shown to be particularly advantageous here if the sealing compound is applied to the subregions and the outflow opening is closed by means of the sealing compound in one go, that is to say in one work step, in particular in such a way that the sealing compound is applied to the subregions and the outflow opening is closed by means of the sealing compound, without interruption between the application of the sealing compound to the subregions and the closing, brought about by the sealing compound, of the outflow opening, during which interruption the sealing compound is not applied to the components.

For example, the sealing compound is provided from a provision device, also referred to as applicator, in particular in such a way that the sealing compound flows out of the applicator, in particular out of at least one outlet opening of the applicator, in order as a result to apply the sealing compound to the subregions, and the outflow opening is closed by means of the sealing compound. The feature that the crimping flange is sealed, and therefore the sealing compound is applied to the subregions and the outflow opening is closed by means of the sealing compound in one go, is to be understood in particular to mean that between the application of the sealing compound to the subregions and the closing of the outflow opening by means of the sealing compound there is no interruption, during which the sealing compound does not exit the applicator. Therefore, it is preferably provided that the sealing compound is applied to the components at least substantially continuously by means of the applicator in such a way that, without interruption, the crimped flange is sealed and therefore the sealing compound is applied to the subregions and the outflow opening is closed by means of the sealing compound. This makes it possible to produce the components in particularly favorable fashion in terms of time and costs, the components can be connected to one another fixedly for a lengthy period of time in particularly advantageous fashion, and the components can be provided with the coating in particularly advantageous fashion without undesired lacks of coating or defects of the coating, and therefore faulty coatings, arising.

The aforementioned structural part is for example a wing element, for example a tailgate, a cover flap, a bonnet or a door, in particular a side door, of the vehicle. The structural part may also be a side wall of the vehicle, in particular a side wall of a body, for example in the form of an integral body, of the vehicle. The structural part may also be a wheel housing of the vehicle, in particular of the body of the vehicle, or a roof of the vehicle, in particular of the body of the vehicle. The structural part may also be a wing element, for example a filler-neck flap or charging flap, in particular for closing a filler-neck and/or charging compartment.

Further details of the invention will emerge from the following description of preferred exemplary embodiments with the associated drawings.

### BRIEF DESCRIPTION OF THE DRAWINGS

FIG. 1 shows a schematic perspective view of a first structural part of a first vehicle, wherein the first structural part comprises a connecting arrangement for connecting a first component to a second component, which is connected to the first component;

FIG. 2 shows a detail of a schematic and sectional perspective view of a first embodiment of the first structural part;

FIG. 3 shows a detail of a further schematic and sectional perspective view of the first structural part according to the first embodiment;

FIG. 4 shows a detail of a schematic and sectional perspective view of the first structural part according to a second embodiment;

FIG. 5 shows a detail of a further schematic and sectional perspective view of the first structural part according to the second embodiment;

FIG. 6 shows a detail of a schematic and sectional perspective view of a third embodiment of the first structural part;

FIG. 7 shows a schematic perspective view of a second structural part of a second vehicle; and

FIG. 8 shows a detail of a schematic and perspective view of the second structural part.

### DETAILED DESCRIPTION OF THE DRAWINGS

In the figures, elements that are the same or have the same function are provided with the same reference signs.

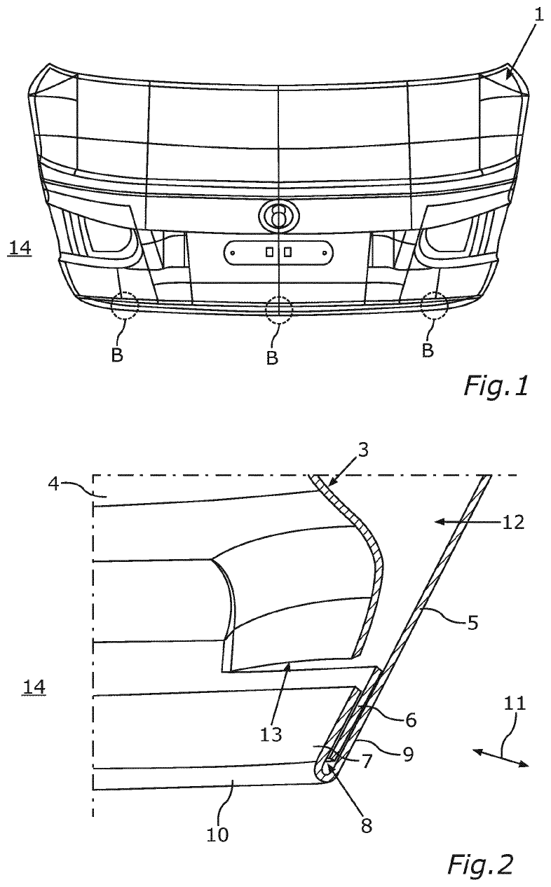

FIG. 1 shows a schematic perspective view of a first structural part 1 for a first vehicle, which is in the form of a passenger car. In the exemplary embodiment shown in FIG. 1, the structural part 1 is designed as a wing element in the form of a tailgate. This means that the first vehicle in its completely produced state comprises a body which is preferably in the form of an integral body and on which the structural part 1 is held movably, in particular pivotably.

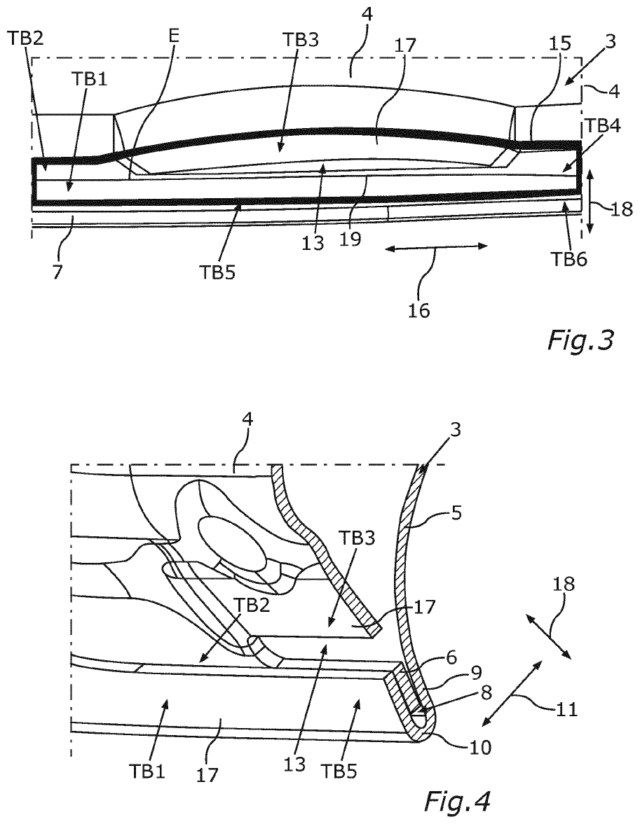

FIGS. 2 and 3 show a first embodiment of the structural part 1. As can be seen particularly well in FIGS. 2 and 3, the structural part 1 comprises a connecting arrangement 3 for connecting a first component 4 to a second component 5 of the structural part 1, wherein in the case of the connecting arrangement 3 a peripheral region 6 of the first component 5 is arranged in a folded pocket 8, which is partially delimited by a crimped flange 7 of the second component 5, of the second component 5, which is crimped around and thus folded over around the peripheral region 6, as a result of which the components 4 and 5 are connected to one another. It can be seen in FIG. 2 that the crimped flange 7 is a first wall region of the component 5. The folded pocket 8 is delimited and thus formed partially by the crimped flange 7 and partially by a second wall region 9 of the component 5. The wall region 9 is situated opposite the crimped flange 7 and is spaced apart from the crimped flange 7. The crimped flange 7 and the wall region 9 are connected to one another via a fold 10 of the component 5, wherein the fold 10 is formed in that the component 5 has been or is crimped around and thus folded over around the peripheral region 6. It is evident that the fold 10 is an arcuate, third wall region of the component 5, wherein the arcuate, third wall region of the component 5 is formed in one piece both with the crimped flange 7 and with the wall region 9. As a result, the wall region 9 is formed in one piece with the crimped flange 7. Moreover, it can be seen in FIG. 2 that the peripheral region 6 is arranged in particular along an arrangement direction, depicted by a double-headed arrow 11 in FIG. 2, between the crimped flange 7 and the wall region 9.

The structural part 1 is produced in particular in that the components 4 and 5, as described above, are connected to one another. After the components 4 and 5 have been connected to one another, the structural part 1 and thus the components 4 and 5 are coated, that is to say provided with a coating. For example, the structural part 1 and thus the components 4 and 5 are painted and as a result provided with the coating, also referred to as paint finish or coat of paint. For example, the structural part 1 and thus the components 4 and 5 are provided with the coating or a respective coating in the course of a pretreatment and/or a cathodic dip coating (CDC) process.

It can be seen in FIG. 2 that the components 4 and 5 delimit, in each case partially directly, at least one interspace 12 arranged between the components 4 and 5. The structural part 1 and thus the components 4 and 5 are provided with the coating in a liquid state of the coating. In other words, the components 4 and 5 are each at least partially brought into in particular direct contact with the still-liquid coating. In the process, the coating enters the interspace 12 in its liquid state.

In order now to both be able to provide the components 4 and 5 with the coating in particularly advantageous fashion and connect the components 4 and 5 to one another in particularly advantageous fashion, the first component 4 has regions, denoted by B in FIG. 1, each of which has at least one or exactly one outflow opening 13, which is in the form of a through-opening and, in the first embodiment shown in FIGS. 2 and 3, is designed as a gill, also referred to as crimped-fold gill. The outflow opening 13 by way of one end leads to the intermediate space 12 and by way of the other end leads to a surroundings 14 of the components 4 and 5 and of the structural part 1 overall, with the result that a liquid and a gas, for example air, can be discharged from the interspace 12 via the outflow opening 13 in particular to the surroundings 14. The liquid is for example liquid excess coating that thus does not remain on the components 4 and 5 and the excess of which now can flow through the outflow opening 13 and thus flow out of the interspace 12. Moreover, the interspace 12 and thus the structural part 1 can be in particular completely ventilated in particularly advantageous fashion via the outflow opening 13. The outflow opening 13 therefore enables a particularly advantageous media outflow or media drainage out of the interspace 12.

In order to be able to ensure a particularly fixed connection between the components 4 and 5 over a long service life and to avoid water, dirt and/or other, in particular corrosive media entering the interspace 12, which is preferably in the form of a dry space, after the components 4 and 5 have been provided with the coating, the outflow opening 13—as can be seen particularly clearly in FIG. 3—is in particular completely closed and thus sealed off by a sealing compound 15, illustrated in transparent view in FIG. 3.

It can be seen particularly clearly in FIG. 3 that the crimped flange 7 extends along a direction of longitudinal extent, depicted by a double-headed arrow 16 in FIG. 3, of the crimped flange 7 in elongate and in particular linear fashion. In this respect, the sealing compound 15 covers both a first subregion TB1 of the crimped flange 7 and a second subregion TB2, which adjoins the first subregion TB1 of the crimped flange 7 and is arranged next to the outflow opening 13, of the first component 4, as a result of which the crimped flange 7 is sealed off at least in the subregion TB1 with respect to the second subregion TB2. Expressed differently again, as a result the crimped flange 7 is sealed, and therefore no dirt and no liquid can pass between the crimped flange 7 and the component 4 and enter the folded pocket 8. It can be seen that the subregion TB2 is arranged next to the outflow opening 13 along the direction of longitudinal extent of the crimped flange 7, and the outflow opening is therefore arranged in a subregion TB3 of the component 4. In the direction of longitudinal extent of the crimped flange 7, a fourth subregion TB4 of the component 4 adjoins the outflow opening 13 and thus the subregion TB3, with the result that the outflow opening 13 or the third partial region TB3 is arranged between the subregions TB1 and TB4 of the component 4 in the direction of longitudinal extent of the crimped flange 7. Accordingly, the crimped flange 7 also has a fifth subregion TB5, which adjoins the subregion TB1 in the direction of longitudinal extent of the crimped flange 7 and thus is arranged at the same height as the subregion TB3 and thus the outlet opening 13 along the direction of longitudinal extent of the crimped flange 7. In the direction of longitudinal extent of the crimped flange 7, the direction of longitudinal extent of which is also referred to as first direction of longitudinal extent, a sixth subregion TB6 of the crimped flange 7 adjoins the subregion TB5, with the result that the subregion TB5 of the crimped flange 7 is arranged between the subregions TB1 and TB6 of the crimped flange 7 in the direction of longitudinal extent of the crimped flange 7. In this respect, the subregions TB1 and TB2 are arranged at the same height in the direction of longitudinal extent of the crimped flange 7, and the subregions TB4 and TB6 are arranged at the same height in the direction of longitudinal extent of the crimped flange 7 (double-headed arrow 16). In the subregion TB3, the component 4 has a wall region 17 which adjoins the outflow opening 13 and partially and directly delimits the outflow opening 13 in a direction away from the crimped flange 7. In this respect, it can be seen in FIG. 3 that the sealing compound 15 covers both the subregions TB1 and TB2 and the subregions TB6 and TB4. Furthermore, the sealing compound 15 covers the subregion TB5 of the crimped flange 7, the outflow opening 13 and the wall region 17, wherein the subregion TB5 of the crimped flange 7 and the subregion TB3 of the component 4 and thus the outflow opening 13 arranged in the subregion TB3 and the wall region 17 arranged in the subregion TB3 are arranged at the same height in the direction of longitudinal extent of the crimped flange 7. In this respect, for example the subregion TB2 and the subregion TB4 directly adjoin the subregions TB1 and TB6, respectively, which are arranged at the same height, of the crimped flange 7.

It can also be seen in FIG. 3 that the subregions TB1, TB3 and TB4 adjoin the subregions TB1, TB5 and TB6, respectively, which are each arranged at the same height, of the crimped flange 7 along a connection direction, wherein the connection direction is depicted by a double-headed arrow 18 in FIG. 3 and extends perpendicularly to the direction of longitudinal extent, depicted by the double-headed arrow 16, of the crimped flange 7. The sealing compound 15 in this respect covers the subregions TB1-6 continuously, that is to say without interruptions, with the result that the crimped flange 7 is sealed off particularly well with respect to the component 4 and the outflow opening 13 is closed and thus sealed off particularly well. The arrangement direction, depicted by the double-headed arrow 11, extends perpendicularly to the connection direction.

In the first embodiment, the first component 4, which has the outflow opening 13 in the form of a crimped-fold gill, is made from a steel and thus from a metal material. It is also conceivable for the component 5 to be made from a metal material, such as a steel or a light metal, in particular aluminum.

By contrast to conventional solutions, the outflow opening 13 improves the drainage behavior in particular while the components 4 and 5 are being provided with the coating, because complete drainage of the excess coating from the interspace 12 is enabled and no residual media that can lead to faulty coatings or lack of coating remain in the interspace 12. Moreover, the connecting arrangement 3 can be produced in particularly cost-effective fashion, since additional, separate assembly plugs for closing the outflow opening 13 can be avoided. The outflow opening 13 can in this respect be closed and sealed off by means of the sealing compound 15 without additional outlay and reliably in terms of the process. Moreover, a particularly advantageous appearance of the structural part 1 can be ensured, since an appearance of a secondary surface on an inner side of the structural parts 1 can be improved over conventional solutions by omitting assembly plugs. Preferably, the sealing compound 15 is made from a plastic, in particular from PVC.

In the first embodiment, the outflow opening 13 is elongate, and therefore the outflow opening 13 has a second direction of longitudinal extent. In the first embodiment, the second direction of longitudinal extent of the outflow opening 13 extends at least substantially parallel to the first direction of longitudinal extent of the crimped flange 7, with the result that the double-headed arrow 16 also depicts the direction of longitudinal extent of the outflow opening 13. Therefore, the subregions TB2 and TB4 of the component 4 adjoin the outflow opening 13 or the subregion TB3 on either side in the direction of longitudinal extent of the outflow opening 13, and the third subregion is thus arranged between the subregions TB2 and TB4 of the component 4 in the direction of longitudinal extent of the outflow opening 13. Moreover, in the first embodiment the outflow opening 13 has an arcuate and half-round or semicircular form.

The outflow opening 13 is partially and directly delimited by the wall region 17 and partially and directly delimited by a further wall region 19 of the component 4, wherein the wall region 19 is situated opposite the wall region 17. In this case, it is preferably provided that an in particular larger distance, which extends in particular perpendicularly to the connection direction and perpendicularly to the direction of longitudinal extent that extends perpendicularly to the connection direction, of the crimped flange 7 and thus of the outflow opening 13, between the wall regions 17 and 19 is at most 3 mm, in particular at most 2 mm, wherein the distance is preferably at least 0.5 mm, in particular at least 1 mm. This makes it possible to ensure for the one part that the outflow opening 13 can be closed and sealed off advantageously by means of the sealing compound 15. For the other part, it can be ensured that the excess liquid can advantageously be discharged from or flow out of the interspace 12 via the outflow opening 13. A length, extending in the direction of longitudinal extent of the outflow opening 13, of the outflow opening 13 is for example in a range of 30 mm to 50 mm inclusive.

An distance, which in particular extends along the connection direction, between an intrinsically free end E, which for example points toward the outflow opening 13 or faces toward the outflow opening 13, of the crimped flange 7 and the outflow opening 13 is for example 2.5 mm, as a result of which it can be ensured that the outflow opening 13 is closed and thus sealed off by means of the sealing compound 15. The outflow opening 13 is produced in the form of a gill, for example such that the outflow opening 13 is produced by cutting and then shaping the first component 4.

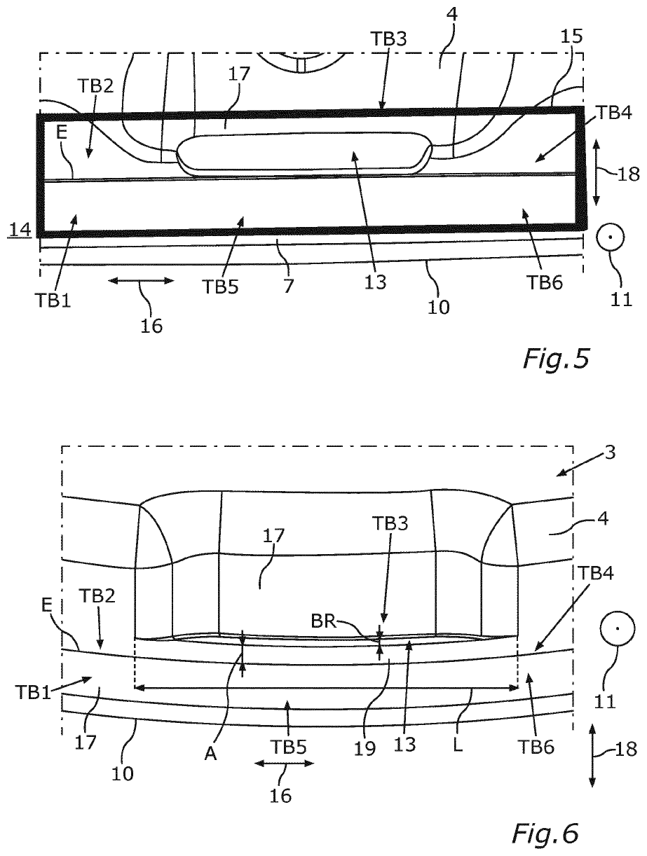

FIGS. 4 and 5 show a second embodiment of the structural part 1, in particular of the connecting arrangement 3. In the second embodiment, the outflow opening 13 is in the form of a slot, which is formed for example by cutting a region of material out of the first component 4. The liquid can flow through the outflow opening 13 from the interspace 12 along a direction of passage. In the first embodiment, the direction of passage goes toward the crimped flange 7, for example. In particular, for example, the direction of passage extends parallel to the connection direction. By contrast, the direction of passage goes away from the crimped flange 7 in the second embodiment. In other words, the direction of passage extends perpendicularly to the connection direction. In the first embodiment, the wall region 19, of which the width that extends for example along the connection direction corresponds to the aforementioned distance, is arranged between the outflow opening 13 and the crimped flange 7, in particular the end E of the crimped flange 7, for example along the connection direction.

In the second embodiment, for example, the outflow opening 13 adjoins the end E along the connection direction at least directly therein, with the result that for example the crimped flange 7 along the connection direction ends at the end E and thus at a location where the outflow opening 13 starts along the connection direction. For example, in the second embodiment, the outflow opening 13 has a width which extends along a direction of extent of the outflow opening 13, the direction of extent of which extends perpendicularly to the direction of longitudinal extent of the outflow opening 13, wherein in the second embodiment the direction of extent of the outflow opening 13 and thus the width of the outflow opening 13 extend parallel to the connection direction or coincide with the connection direction (double-headed arrow 18). For example, the width is 3.5 mm. Since, moreover, the outflow opening 13 in the second embodiment directly adjoins the end E along the connection direction, a distance that extends along the connection direction between the end E and the outflow opening 13 is 0.0 mm. Preferably, in the second embodiment the component 4 is made from a light metal, in particular aluminum.

Lastly, FIG. 6 shows a third embodiment of the structural part 1 and thus of the connecting arrangement 3. In the third embodiment, the outflow opening 13 is in the form of a gill, with the result that the third embodiment basically corresponds to the first embodiment. The third embodiment differs from the second embodiment in particular in that the outflow opening 13 in the third embodiment has a polygonal form, and therefore a polygonal cross section through which the liquid from the interspace 12 can flow. In FIG. 3, the distance, which extends in particular along the connection direction (double-headed arrow 18), between the end E of the crimped flange 7 and the outflow opening 13 is denoted by A, and the length, which extends in the direction of longitudinal extent (double-headed arrow 16) of the outflow opening 13, of the outflow opening 13 is denoted by L in FIG. 6. Furthermore, a width of the outflow opening 13 is denoted by BR, the width BR of the outflow opening extending perpendicularly to the direction of passage through the outflow opening 13 and extending in a plane that extends perpendicularly to the direction of passage, wherein the direction of longitudinal extent of the outflow opening 13 extends in the plane. For example, the width BR is 2.0 mm. The width BR corresponds for example to the width, which was described above and extends along the connection direction, of the outflow opening 13, in the form of a slot, in the second embodiment.

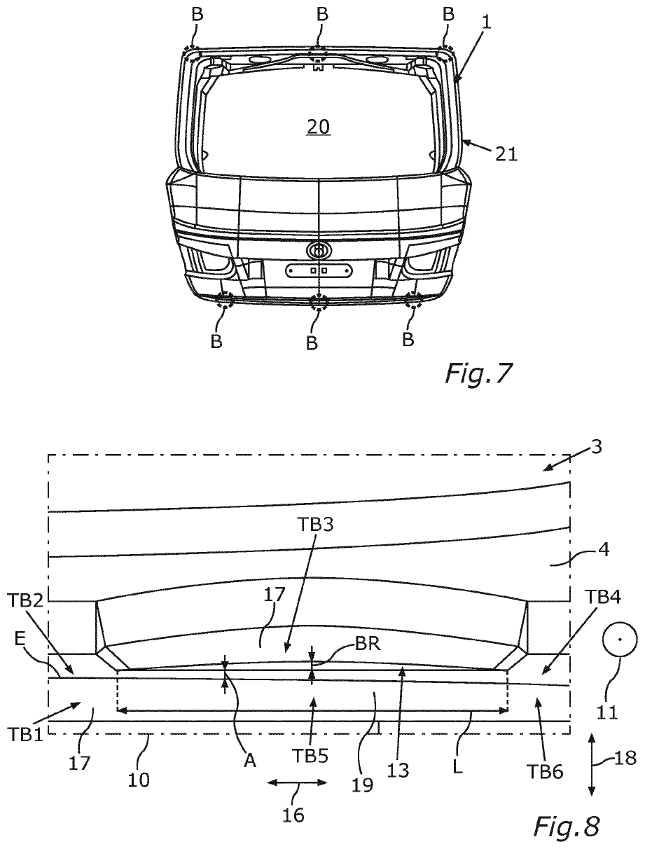

FIG. 7 shows a schematic perspective view of a second structural part 1′ for a second vehicle, which is also in the form of a passenger car. It is also the case in the exemplary embodiment shown in FIG. 7 that the structural part 1′ is in the form of a wing element in the form of a tailgate. This means that the second vehicle in its completely produced state has a body, preferably in the form of an integral body, on which the structural part 1′ is held movably, in particular pivotably.

The above and below statements relating to the first structural part 1 can readily also be transferred to the second structural part 1′ and vice versa. It can be seen in FIG. 8 that the structural part 1′ also has a connecting arrangement 3 for connecting a first component 4 to a second component 5 of the structural part 1′. By contrast to the structural part 1, the structural part 1′ has a window opening 20, which is delimited for example by a window frame 21, also referred to simply as frame, of the structural part 1′. In the completely produced state of the second vehicle, a transparent pane is used in the window opening 20 that is held on the structural part 1′ and is in the form of a rear window of the second vehicle.

### LIST OF REFERENCE CHARACTERS

1, 1′ Structural part
3 Connecting arrangement
4 First structural element
5 Second structural element
6 Peripheral region
7 Crimped flange
8 Folded pocket
9 Wall region
10 Fold
11 Double-headed arrow
12 Interspace
13 Outflow opening
14 Surroundings
15 Sealing compound
16 Double-headed arrow
17 Wall region
18 Double-headed arrow
19 Wall region
20 Window opening
21 Window frame
A Distance
B Region
BR Width
E End
L Length
TB1-6 Subregion

1.-10. (canceled)

11. A connecting arrangement for connecting a first component to a second component for a vehicle, comprising:
a peripheral region of the first component that is disposed in a folded pocket of the second component that is delimited by a crimped flange of the second component, wherein the crimped flange is crimped around the peripheral region such that the first component is connected to the second component;
wherein the first component has an outflow opening which adjoins the crimped flange and wherein a liquid is dischargeable via the outflow opening from an interspace delimited by the first component and the second component;
wherein the outflow opening is closed by a sealing compound which covers a first subregion of the crimped flange and a second subregion, which adjoins the first subregion of the crimped flange and is disposed next to the outflow opening, of the first component, and thus, seals off the crimped flange with respect to the second subregion.

12. The connecting arrangement according to claim 11, wherein the outflow opening is elongate.

13. The connecting arrangement according to claim 12, wherein the outflow opening has a direction of longitudinal extent which extends obliquely or parallel to a direction of longitudinal extent of the crimped flange.

14. The connecting arrangement according to claim 11, wherein the outflow opening is a region of material cut out of the first component.

15. The connecting arrangement according to claim 11, wherein the outflow opening is a shaped cut in the first component.

16. The connecting arrangement according to claim 11, wherein the sealing compound is a plastic.

17. The connecting arrangement according to claim 16, wherein the plastic is polyvinyl chloride.

18. The connecting arrangement according to claim 11, wherein a distance between a free end of the crimped flange and the outflow opening is at most three millimeters.

19. The connecting arrangement according to claim 11, wherein the first component and/or the second component is a metal material.

20. A method for connecting a first component to a second component for a vehicle, comprising the steps of:
crimping the second component around a peripheral region of the first component such that a folded pocket delimited by a crimped flange of the second component is formed and the peripheral region of the first component is disposed in the folded pocket and such that the first component is connected to the second component;
wherein the first component has an outflow opening adjoining the crimped flange;
providing the first component and the second component with a coating and discharging excess coating from an interspace delimited by the first component and the second component via the outflow opening; and
applying a sealing compound to a first subregion of the crimped flange and a second subregion, which adjoins the first subregion of the crimped flange and is disposed next to the outflow opening, of the first component, such that the sealing compound covers the first subregion and the second subregion to seal off the crimped flange with respect to the second subregion;
wherein the outflow opening is closed by the sealing compound.
